(19) United States
(12) Patent Application Publication
(10) Pub. No.: US 2005/0190647 A1
(43) Pub. Date: Sep. 1, 2005

(54) Peanut butter stirrer

(76) Inventor: Steven Rosati, Alta Loma, CA (US)

Correspondence Address: Lewis M. Brande, 5976 Falling Tree Lane, Alta Loma, CA, 91737-2816, US

(21) Appl. No.: 10/788,942

(22) Filed: Feb. 28, 2004

(51) Int. Cl. B01F 13/00

(52) U.S. Cl. 366/343

(57) ABSTRACT

The current invention describes a tool for mixing natural peanut butter, when the peanut butter has separated into an oily layer and a sedimentary layer. Traditional peanut butter spreaders are generally made of soft materials, such as plastic, and don't have the structural strength to mix the separated peanut butter, especially when the peanut butter is refrigerated. The current invention overcomes that by utilizing a handle, a rigid metal shaft and a inflexible metal mixing blade.

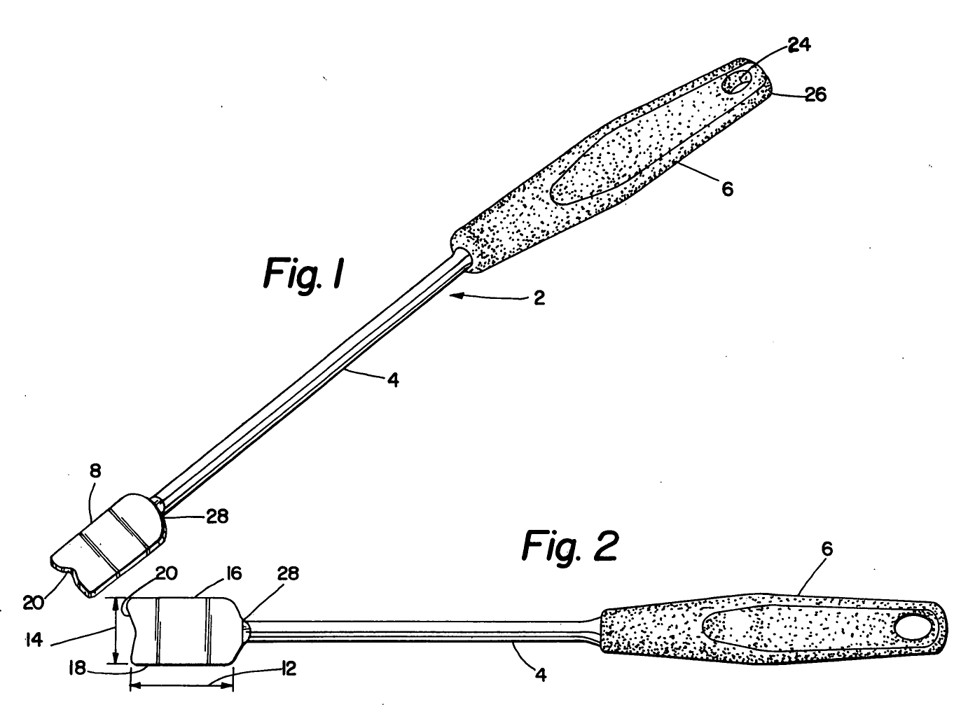

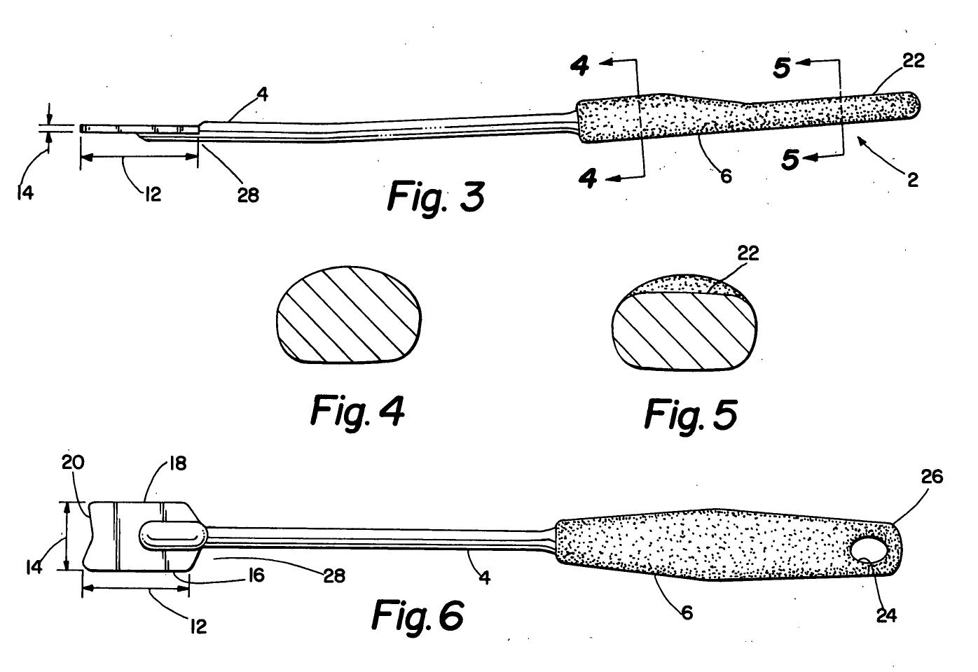

### BACKGROUND OF THE INVENTION

1. Field of the invention

The present invention is in the field of kitchen utensils. More specifically, stirring implements. The present invention pertains to a kitchen utensil that is specifically used to stir natural peanut butter. Natural peanut butter, from companies such as Laura Scudders® typically settle out. Over time the solid peanut butter separates from the peanut oil in the jar. When someone wants to spread the peanut butter, they must use either a knife, or another type of utensil that is not specifically made to stir a highly viscous product such as separated peanut butter. Knives are very slender, and are somewhat short, causing the users hands to become soiled.

2. Description of the Prior art

Various types of stirring implements are known in the prior art.

U.S. Pat. No. 4,924,444 by Castellanos discloses a “Stirring Implement”. This implement has an elongated shaft connected to a thin flat blade that is “paddle shaped”. The paddle has parallel sides and has rounded corners in order to be able to stir at the bottom of containers, thus increasing efficiency. The “paddle” is disclosed and described as a thin flat blade. This is where the prior art differs from the present invention. The present invention uses a much thicker blade in order to be able to mix thickened peanut butter. The thin flat blade of the instant patent is unable to mix such a material as the blade is too thin. Additionally, the Castellanos patent discloses a use of mixing the bottom surface of a beverage container, and being more efficient than the small cylinders used to mix hot beverages.

U.S. Pat. No. 1,426,085 by Kohn, discloses a “Butter Spreader”. This invention is describing an improved butter spreader. The Kohn patent describes a knife with serrations that allow the butter to be more evenly spread butter because the serrations prevent the butter from lumping when scraped. Although the Kohn invention may be used to spread products, the intended purpose of the patent is very specific and narrow towards spreading butter.

### SUMMARY OF THE INVENTION

In view of the foregoing disadvantages inherent in the known types of stirring implements now present in the prior art, the present invention provides and improves mixing implement for peanut butter. As such the general purpose of the present invention, which will be described subsequently in greater detail, is to provide a new and improved stirring implement which has all the advantages of the prior art and none of the disadvantages.

To attain this, the present invention is illustrated in the drawings and make use of a stirring implement designed to mix natural peanut butter, and consists of a flat blade attached to an elongated shaft.

### DESCRIPTION OF THE DRAWINGS

Figure one shows a perspective view of the peanut butter stirrer

Figure two shows a plan view of the peanut butter stirrer

Figure three shows a side view of the peanut butter stirrer

Figure four shows a cross section of the handle

Figure five shows an additional cross sectional view of the handle

Figure six shows a back view of the peanut butter stirrer

### DETAILED DESCRIPTION OF THE PREFERRED EMBODIMENTS

With respect to figure one, a peanut butter stirrer (2) is shown having a rigid elongated cylindrical shaft (4). A handle (6) is shown on one end of the rigid elongated cylindrical shaft (4). An essentially flat mixing blade (8) is shown attached to a distal end (28) of the rigid elongated cylindrical shaft (4). The flat mixing blade (8) is somewhat inflexible and has a thickness (10), a length (12), and a width (14). The width (14) may have sides (16), and (18) that are parallel. The sides (16), and (18) are smoothly connected to an bottom end (20), the bottom end (20) being either flat or having a curved shape to match the bottom of a peanut butter jar (not shown) thereby allowing the easy removal of residual peanut butter. Generally the preferred material for the rigid elongated shaft (6) and the flat mixing blade (8) is metal, which is common in the industry of food or serving utensils. Metals such as Stainless Steel, and aluminum are common in the utensil industry. Plastic is generally not used because it becomes very brittle with constant washing in dishwashers due to the repeated heat cycles. Plastic may also be prone to bacteria growth in crevices due to the rough microstructure of the material.

The handle (6) is essentially circular at the attaching point of the elongated cylindrical shaft (4). The handle (6) then tapers to a central flat portion (22) to allow for easy grasping by a consumer. At a distal end (26) of the handle (6), a hanging hole (24) is positioned. An alternative embodiment of the handle (6) is where the handle (6) is a thin elliptical shape common in the field of utensils.

1. A peanut butter stirrer, comprising;
a. a rigid elongated cylindrical shaft, a handle, said handle being attached at an end of said rigid elongated cylindrical shaft, a mixing blade, said mixing blade being attached at a distal end of said rigid elongated cylindrical shaft; and
b. said mixing blade having sides, said sided being smoothly connected to a bottom end.

2. The peanut butter stirrer of claim 1, wherein said rigid elongated cylindrical shaft, and said mixing blade are made of metal common in the utensil industry.

3. The peanut butter stirrer of claim 1, wherein said bottom end of said mixing blade is flat.

4. The peanut butter stirrer of claim 1, wherein said bottom end of said mixing blade has a curved shape, said curved shape being defined by the bottom of a peanut butter container

5. The peanut butter stirrer of claim 1, wherein said handle is elliptically shaped.

6. The peanut butter stirrer of claim 1, wherein said handle has a central flat portion, said central flat portion being located at a distal end from said rigid elongated shaft, said handle having a hanging means defined therein.

7. The peanut butter stirrer of claim 6, wherein said hanging means is a hole, said hole being positioned at a distal end of said handle.
